(19) United States
(12) Patent Application Publication
(10) Pub. No.: US 2003/0046308 A1
(43) Pub. Date: Mar. 6, 2003

(54) Issue tracking system and method

(76) Inventors: Annette Weber, Allegan, MI (US); Deborah Chrisman, Rochester Hills, MI (US)

Correspondence Address: Steven S. Rubin, DICKSTEIN SHAPIRO MORIN & OSHINSKY LLP, 41st Floor, 1177 Avenue of the Americas, New York, NY, 10036-2714, US

(21) Appl. No.: 10/193,193

(22) Filed: Jul. 12, 2002

Related U.S. Application Data
(60) Provisional application No. 60/304,844, filed on Jul. 12, 2001.

(51) Int. Cl. G06F 17/00

(52) U.S. Cl. 707/104.1

(57) ABSTRACT

A system for processing issues comprising a system processor and at least one terminal coupled to the system processor through a network. A database is also coupled to the system processor. The terminal sends issue information through the network to the system processor, the issue information relating to an issue. The system processor stores the issue information in the database. The system processor also receives resolution information through the network, the resolution information relating to a resolution of the issue. The system processor stores the resolution information in the database. Upon request, the resolution information and issue information may be accessed by users of the system. Users may also enter follow-ups to resolutions.

### CROSS REFERENCE TO RELATED APPLICATIONS

This application claims priority to provisional application No. 60/304,844, filed on Jul. 12, 2001; the entirety of which is hereby incorporated by reference.

### BACKGROUND OF THE INVENTION

The present invention relates to a system and method for electronically tracking problems and other issues, and in particular to a system and method which manufacturers, field management, in-store merchandising specialists, retailers and store personnel use a communication network to allow users to submit and resolve in-store condition, merchandiser performance, product display and product service-related issues.

The system and method will be described in relation to one of its possible fields of use, namely, merchandising.

Manufacturers who sell their goods in retail stores desire effective advertisement and placement of their goods on display for prospective customers. The responsibility for displaying merchandise in retail stores often remains with a merchandising specialist. As a result, manufacturers hire in-store merchandising companies to assemble and arrange the physical displays and layouts of their products in retail stores. In-store merchandising companies also provide other services such as product return management to facilitate the return of defective or damaged products, or unsold overstock.

In-store merchandising companies often dispatch thousands of hired specialists who attend to the product displays and stock conditions in stores. These merchandising specialists are provided with the detailed instructions needed to set up the displays and manage stock or point of sale materials. Instructions change based on manufacturer's initiatives and product offerings in store. Merchandising specialists must rely on the instructions to properly configure displays, restock shelves, process returns, or conduct other merchandising activities at retail store locations. Often these instructions very by store location within the same retail chain. The types of services these specialists provide include initial setup, continued management of physical product displays, introduction of new products to the public, and continued product display support. In addition, product returns can be handled efficiently by merchandising specialists, which results in financial savings for the manufacturers who can pass the savings on to consumers.

Occasionally, problems arise which require immediate communication among the in-store merchandising company, the manufacturer, the retailer, the merchandising specialists, or with store employees. Examples of these problems include damaged physical displays, late shipments of displays and/or products, problems with performance of services, missing or damaged items on display and scheduling conflicts resulting in service specialists' inability to physically meet store employees and management.

Products are typically shipped separately from the displays. Occasionally, problems occur in that products are shipped late or do not arrive at correct destinations. In addition to problems that arise, other issues may require immediate communication among manufacturers, retailers, merchandising specialists, store personnel or in-store merchandising companies. Examples of such issues include situations when a store has recently become ready for a particular display, changes in the physical location of a display within a store in order to boost sales of a particular product and scheduling of meetings between various personnel. For the sake of clarity, the terms “issue” and “problem” will sometimes be used interchangeably throughout.

A variety of participants in the product chain need to communicate in-store and product return issues or monitor related communications with each other. Manufacturers, store managers, district managers (e.g. field management), claims clerks, store department managers, product display supervisors, account supervisors and merchandising specialists all have an interest in participating in in-store and product return- related discourse. Often, information regarding the status of products and issues needs to be made available to one or more of these parties. Traditional communication methods are inefficient in that one person may be responsible for contacting all parties in the product chain and therefore may repeat the same information several times.

Traditional methods of communication to identify and resolve product-related problems and issues include telephone calls, written e-mails, letters and in-person meetings. These traditional communication methods are inefficient because they provide no wide-scale interactive tracking method to monitor issue resolution agreements or actual completion of an agreed solution. By using traditional communication methods, field supervisors waste time monitoring their specialists' activities and communicating with specialists, merchants and stores regarding an issue resolution. Occasionally, store personnel incorrectly identify a problem where none exists and the product display supervisors and merchandising specialists may waste hours discussing these non-problems.

Prior art, Internet-based “help desk” applications are available and used for problem determination and resolution. In share Internet-based help desks, users log into a system, report a problem and then await resolution either by telephone call, e-mail instructions or in-person support. However these applications typically service a closed group of people, such as employees within an institution. Additionally, no wide-scale Internet-based application is currently available for manufacturers, stores and other interested parties regarding in-store and product return services.

It is desirable for stores requiring in-store or product return services to communicate efficiently in order to resolve issues quickly and ensure effective use of human resources. Rather than requiring one person or a small number of people to repeat a problem or issue to a host of others, it is desirable that a plurality of people communicate via a network and receive the same communication first hand and substantially instantaneously. It is also desirable to have an on-line resource whereby an unlimited number of users can log in and enter, monitor or resolve the types of product-related problems and issues discussed above.

It is further desirable to have a system and method whereby interested parties are automatically notified via follow-up e-mail communications for issues that are resolved, not completely resolved or could resurface in the future. Ideally, staff of the provider of the system should not be required to send follow-up communications manually to selected individuals or groups regarding any in-store or product return-related issue. It is desired that users of the system enter their own follow up requests independently and that the follow-up communications are triggered automatically thereafter.

A system is desired which provides information that immediately displays graphically on a series of detailed field status reports what is happening with a program on a national basis or in a single store. Manufacturers, retailers) store personnel, field management, and product display specialists desire to use a software application having the capability to receive and process up-to-the-minute action information detailing the individual status of every store being serviced. It is desirable to have a system which implements real-time field updating such that more stores get more of the attention they need faster. The system should also be capable of utilizing any applicable medium of communication that is either now in existence or yet to be developed, including letter, phone, e-mail, voicemail, streaming video, graphics and so forth. Such a system will allow merchandising programs to operate at peak efficiency thereby increasing sales and customer satisfaction.

### SUMMARY OF THE INVENTION

A system for processing issues comprising a system processor and at least one terminal coupled to the system processor through a network. A database is also coupled to the system processor. The terminal sends issue information through the network to the system processor, the issue information relating to an issue. The system processor stores the issue information in the database. The system processor also receives resolution information through the network, the resolution information relating to a resolution of the issue. The system processor stores the resolution information in the database. Upon request, the resolution information, issue information and fixture information may be accessed by users of the system. Users may also enter follow-ups to resolutions.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown.

FIG. 1 is a diagram of an example hardware arrangement for a an in-store issue management system constructed in accordance with the principles of the present invention.

FIG. 2 is a block diagram of the functional elements of site processors and user terminals constructed in accordance with the principles of the present invention.

FIG. 3 is a flow chart showing processes performed in the present invention.

FIG. 4 is a flow chart showing the processes of adding, resolving and adding follow-up issues.

FIG. 5 is an example of a display screen through which a user navigates within a web site constructed in accordance with the principles of the present invention.

FIG. 6 is an example of a new issue addition user terminal display screen from which a user adds a new issue.

FIG. 7 is an example of a user terminal display screen from which a user indicates details corresponding to an added issue.

FIG. 8 is an example of a user terminal display screen confirming that a user has successfully entered a new issue.

FIG. 9 is an example of a user terminal display screen through which a user selects and enters specific criteria to generate reports, resolutions, and follow-ups.

FIG. 10 is an example of an issue detail user terminal display screen.

FIG. 11 is an example of a user terminal display screen through which a user enters information for in-store issue resolutions.

FIG. 12 is an example of a user terminal display screen confirming that a user has successfully entered an in-store issue resolution.

FIG. 13 is an example of a user terminal display screen through which a user enters information for in-store issue follow-ups.

FIG. 14 is an example of a user terminal display screen confirming that a user has successfully entered an in-store issue follow-up.

FIG. 15 is an example of a user terminal display screen showing statistics regarding the number of in-store issues corresponding to one or more search criteria.

FIG. 16 is an example of a user terminal display screen through which a user enters store fixture assessments.

FIG. 17 is an example of a user terminal display screen showing the results of a fixture report.

FIG. 18 is an example of an issue activity report produced in accordance with the invention.

FIG. 19 is an example of a retail issues tracking report produced in accordance with the invention.

FIG. 20 is an example of a store lookup query screen which may be used in accordance with the invention.

### DETAILED DESCRIPTION OF THE INVENTION

As used herein, the term “web site” refers to a related set of files which are maintained in one or more “web servers” and which, when transmitted to a user terminal, cause the user terminal to display and/or execute programmatic operations corresponding to the data contained in the files. Typically, the files comprising the web site are prepared using one or more of a combination of Hypertext Mark-Up Language (HTML), Extendable Mark-Up Language (XML), Java Applets, ActiveX programs, Standard Generalized Mark-Up Language (SGML) files and the like. Web site files are typically transmitted to the user terminal using one or more protocols such as the Hypertext Transfer Protocol (HTTP) under the Transmission Control Protocol/Internet Protocol (TCP/IP) suite of communication protocols.

Also as used herein, the term “browser” refers to an application program residing and executing on the user terminal which functions as an HTTP client, sending requests to web servers for web site files. The requests are typically sent in the form of a Uniform Resource Locator (URL) or by selecting a hypertext link presented on the user terminal display. The browser functions to format the file and/or data received from the web server and format the received files and/or data in the manner described therein, displaying the same on the user terminal. Examples of browser programs include MICROSOFT INTERNET EXPLORER and NETSCAPE COMMUNICATOR.

As used herein, the term “link” refers to a selectable connection from one or more words, pictures or other information objects to others in which the selectable connection is presented within the web browser. The information object can include sound and/or motion video. Selection is typically made by “clicking” on the link using an input device such as a mouse, track ball and the like. Of course, one of ordinary skill in the art will appreciate that any method by which an object presented on the screen can be selected is sufficient.

Also as used herein, the term “manufacturer” refers to a person or group of people who produce and/or distribute products to be sold in retail stores. Manufacturers or retailers are typically the parties who contract the services of “in-store merchandising companies.”

As used herein, the term “in-store merchandising company” refers to entities who provide services which preferably include assembling and arranging the physical displays and layouts of a manufacturer's products, product stocking, cut-ins, returns, inventories, and data collection. In-store merchandising companies hire “merchandising specialists” defined herein as individuals who are supervised and trained by “field management” to control product display assemblies and related product issues and problems.

Also as used herein, the term “store chain” refers to a retail store company name. The store chain typically comprises more than one physical store location. As used herein, the term “store number” refers to the physical store that is owned by its corresponding store chain. For example, K-MART is an example of a store chain and K-MART Store 113 is an example of a store number.

As used herein, the term “store personnel” refers to employees and managers of retail stores who offer manufacturer's products for sale. Store personnel typically work with merchandising specialists in the implementation and management of product displays and in-store issues.

As used herein, the term “retailer” refers to a representative or representatives of store chain headquarters or management.

Also as used herein, “fixtures” are defined as the physical structures and accessories used in product displays, which contain the product and the advertisements therefor.

Referring now to the drawings figures in which like reference numerals refer to like elements, there is shown in FIG. 1 a diagram of an example issue tracking system constructed in accordance with the principles of the present invention and designated generally as product display or in-store issue tracking system 2. In-store issue tracking system 2 is preferably comprised of one or more site/system processors 4 coupled to one or more user terminals 6 across communication network 8.

Site processor 4 preferably includes all databases 5 necessary to support the present invention. However, it is contemplated that site processor 4 can access any required databases via communication network 8 or any other communication network to which site processor 4 may be coupled. If separate, site processor 4 can communicate with database 5 using any known communication method including a direct serial or parallel interface, or via a local or wide area network.

User terminals 6 communicate with site processors 4 using data connections 9, which are respectively coupled to communication network 8. Communication network 8 can be any communication network, but is typically the Internet or some other global computer network. Data connections 9 can be any known arrangement for accessing communication network 8 such as dial-up serial line interface protocol/point-to-point protocol (SLIP/PPP), integrated services digital network (ISDN), dedicated leased-line service, broadband (cable) access, frame relay, digital subscriber line (DSL), asynchronous transfer mode (ATM) or other access techniques.

User terminals 6 have the ability to send and receive data across communication network 8, and are equipped with web browsers to display the received data on display devices incorporated therewith. By way of example, user terminals 6 may be personal computers such as Intel Pentium-class computers or Apple Macintosh computers, but are not limited to such computers. Other terminals which can communicate over a global computer network such as palmtop computers, personal digital assistants (PDAs) and mass-marketed Internet access devices such as WebTV can be used.

In addition, the hardware arrangement of the present invention is not limited to devices, which are physically wired to communication network 8. It is contemplated that wireless devices using a wireless application protocol (WAP) can interoperate with site processors 4 using wireless data communication connections.

In addition to computer-related methods to access the system, parties who are not able to access the in-store issue tracking system 2 via a computer or related device including, for example, a hand-held device (e.g. a PDA), can write physical letters 10, send e-mails, voice mails, or make telephone calls 11 to the in-store merchandising company and report in-store related issues therefor. Once the letter 10 and/or telephone call 11 is received, data-entry personnel for the in-store merchandising company can make the necessary entries into site processor 4.

According to the present invention, user terminal 6 provides user access to site processors 4 for the purpose of receiving and providing in-store-related issue tracking. The specific functionality provided by in-store issue tracking system 2, and in particular site processors 4, is described in detail below.

In-store issue tracking system 2 employs software, which controls in-store-related issue tracking management functions. This software preferably resides on one or more site processors 4. One of the functions performed by site processor 4 is that of operating as a web server and a web site host. Site processors 4 typically communicate with communication network 8 across a permanent i.e., unswitched data connection 9. Permanent connectivity ensures that access to site processors 4 is always available.

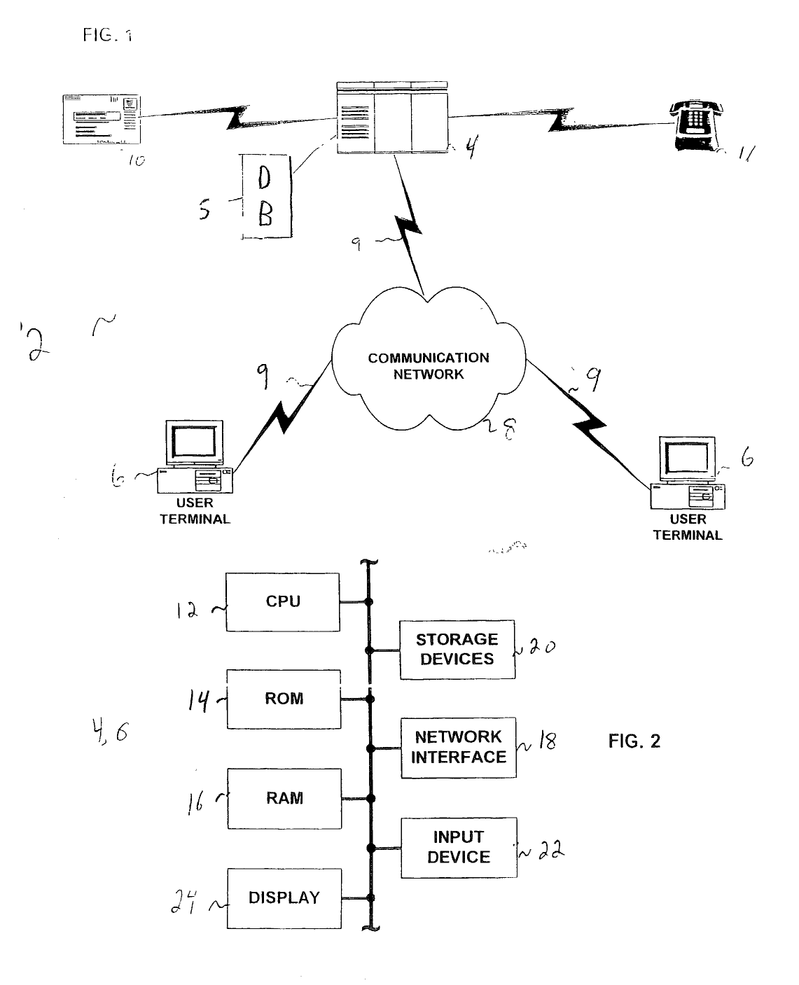

As shown in FIG. 2 the functional elements of each site processor 4 and user terminal preferably include one or more central processing units (CPU) 12 used to execute software code in order to control the operation of site processor 4, read only memory (ROM) 14, random access memory (RAM) 16, one or more network interfaces 18 to transmit and receive data to and from other computing devices across a communication network, storage devices 20 such as a hard disk drive, floppy disk drive, tape drive, CD-ROM or DVD drive for storing program code, databases and application code, one or more input devices 22 such as a keyboard, mouse, track ball and the like, and a display 24.

The various components of site processor 4 need not be physically contained within the same chasse or even located in a single location. For example, as explained above with respect to databases which can reside on storage device 20, storage device 20 may be located at a site which is remote from the remaining elements of site processors 4, and may even be connected to CPU 12 across communication network 8 via network interface 18.

In user terminals 6, not all elements 12-24 need be present. Further, the capacities of the various elements are arranged to accommodate the expected user demand. For example, CPU 12 in user terminal 6 may be of a smaller capacity than CPU 12 as present in site processor 4. Similarly, it is likely that site processor 4 will include storage devices 20 of a much higher capacity than storage devices 20 present in user terminal 6. Of course, one of ordinary skill in the art will understand that the capacities of the functional elements can be adjusted as needed.

The nature of the present invention is such that one skilled in the art of writing computer executed code (software) can implement the described functions using one or more or a combination of a popular computer programming language including but not limited to C++, Visual Basic, Java, ActiveX, HTML, and web application development environments.

As used herein, references to displaying data on user terminal 6 refer to the process of communicating data to the terminal across communication network 8 and processing the data such that the data can be viewed on the terminals display 24 using a web browser or the like. The display screen on terminals 6 present areas within in-store issue tracking system 2 such that a user can proceed from area to area within the in-store issue tracking system 2 by selecting a desired link. Therefore, each user's experience with in-store issue tracking system 2 will be based on the order with which they progress through the display screens. In other words, because the system is not completely hierarchical in its arrangement of display screens, users can proceed from area to area without the need to backtrack through a series of display screens. For that reason, unless stated otherwise, the following discussion is not intended to represent any sequential operation steps, but rather to describe the components of in-store issue tracking system 2 without specifying any particular sequence in which the display screens must be displayed.

Although the present invention is described by way of example herein in terms of a web-based system using web browsers and a web site server (site processor 4), in-store issue tracking system 2 is not limited to that particular configuration. In-store issue tracking system 2 can be arranged such that user terminal 6 can communicate with, and display data received from, site processor 4 using any known communication and display method. For example, communication could be through using a non-Internet browser Windows viewer coupled with a local area network protocol such as the Internetwork Packet Exchange (IPX). Any suitable operating system can be used on user terminal 6, for example, any version of Windows, MAC 0S, LINUX or any suitable PDA or palm computer operating system.

In-store issue tracking system 2 provides a comprehensive, yet easy to use, web site from which users can navigate to receive or provide information relating to problems or issues on product displays, product display services or product display products.

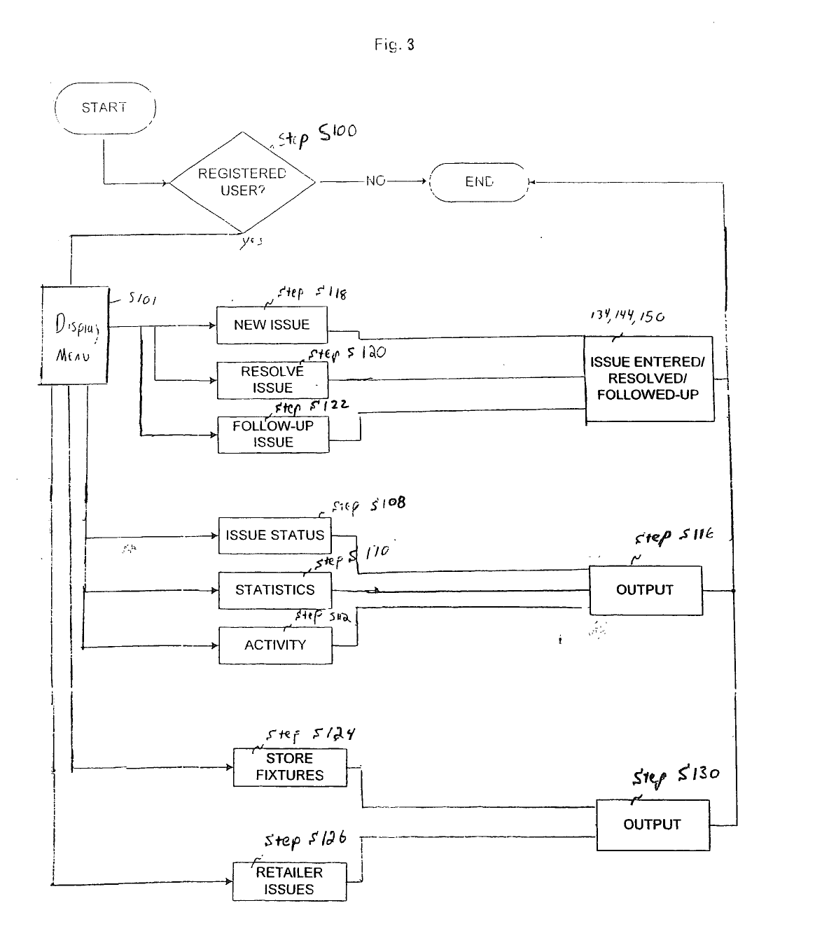

Access to the various functions provided by in-store issue tracking system 2 are explained with reference to FIG. 3. The services provided by in-store issue tracking system 2 are preferably arranged as a web site through which the user selects choices and functions. Initially, a user accesses the web site provided by site processor 4 by entering a URL corresponding to the network address of the web site.

A determination is then made as to whether a user seeking to utilize in-store issue tracking system 2 is registered at step S100. This determination is preferably made by site processor 4 by accepting log-in information from user terminal 6 corresponding to the user's I.D. and password. Preferably, in-store issue tracking system 2 is arranged such that the user is not able to access the in-store issue tracking system if the user is not registered.

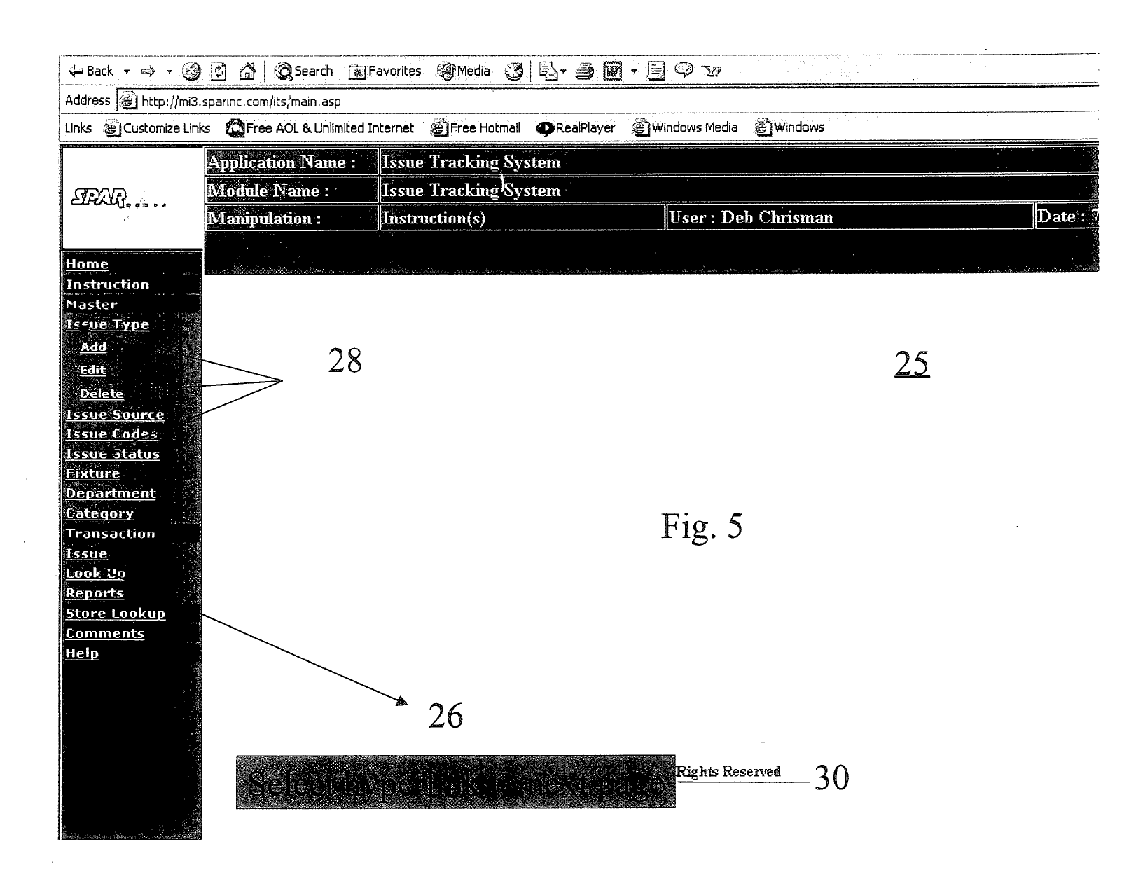

If the user's registration is authenticated, the user is presented (step S101) with a main menu display screen 25 as shown in FIG. 5. The example of in-store issue main menu display screen 25 substantially as shown in FIG. 5 is preferably comprised of one or more graphic controls including, but not limited to, title bars, labels, text input areas, radio and push buttons. Of course, other design layouts can be fashioned using other types of graphic display controls known to those skilled in the art.

When selecting the graphic controls in in-store issue main menu display screen 25, content corresponding to the selections is caused to be displayed in another web page. In-store issue main menu display screen 25 is preferably presented in the case where the user has not selected a particular function such as occurs when a user terminal receives the initial display screen data from site processor 4.

The main menu enables the user to make selections, which carry out the functions of in-store issue tracking system 2. The user is initially prompted as to whether he wants: 1) issue data; 2) a report; or 3) view issue tracking summary data. Each of these choices are discussed in detail.

As shown in FIG. 5, main menu display screen 25 includes an issue report area 26 which in turn, preferably includes options relating to issues status reports, statistic reports, activity reports and to generate tracking reports for store fixtures and retailer issues. An issue action area 28 provides options to generate new issues, resolve existing issues, and schedule follow-ups to existing issues. Regardless of the selection made, the user invokes his choice by clicking on next button 30. Once the user presses next button 30, content corresponding to the selected control is caused to be displayed in another web page.

Product display issues relate to concerns or problems regarding the placement and display of manufacturers' goods that are advertised and on sale in stores. Product displays often comprise fixtures, which are the physical structures and accessories containing the product and the advertisements.

Examples of in-store issues include defects in fixtures, incorrect installations of fixtures, product shipment errors, merchandising specialist performance problems, store readiness and product returns. In-store issues usually require communication among manufacturers, in-store-merchandising companies, merchandising specialists and store personnel for a successful resolution to the issue.

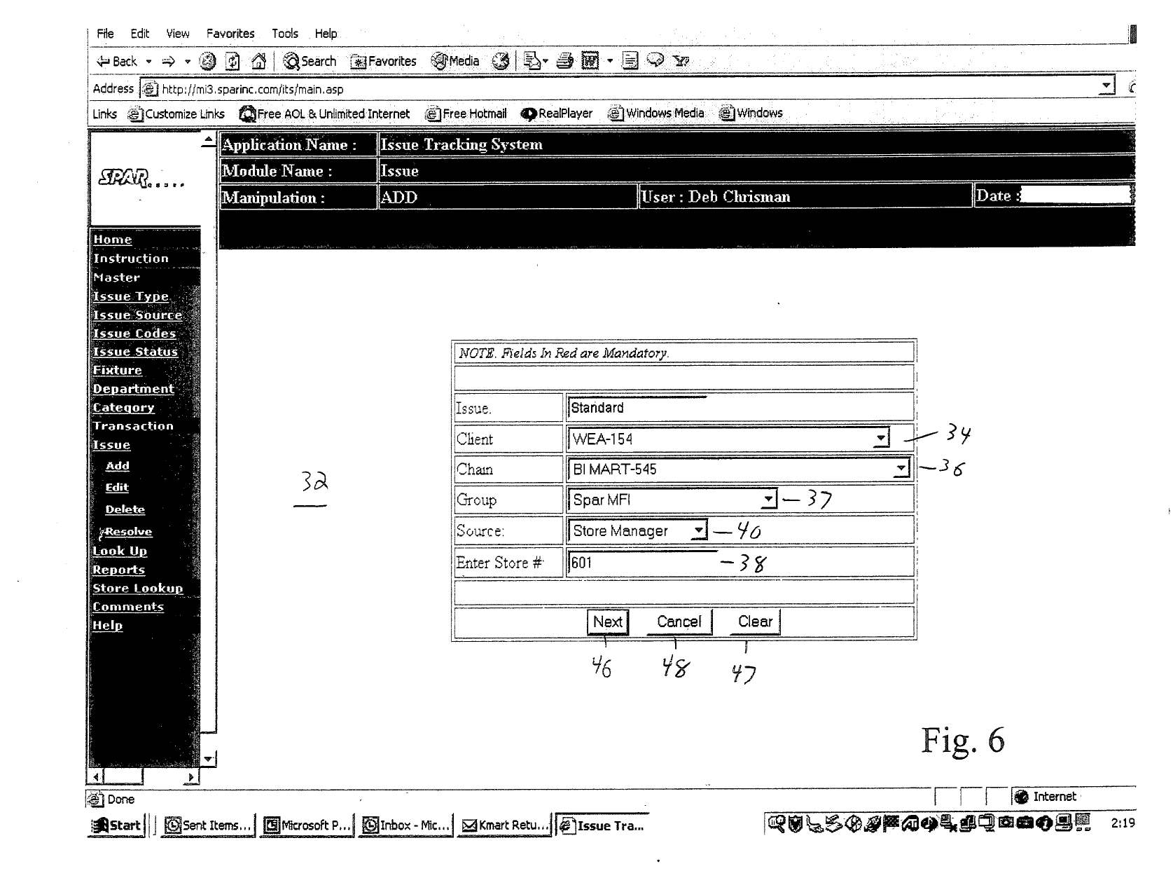

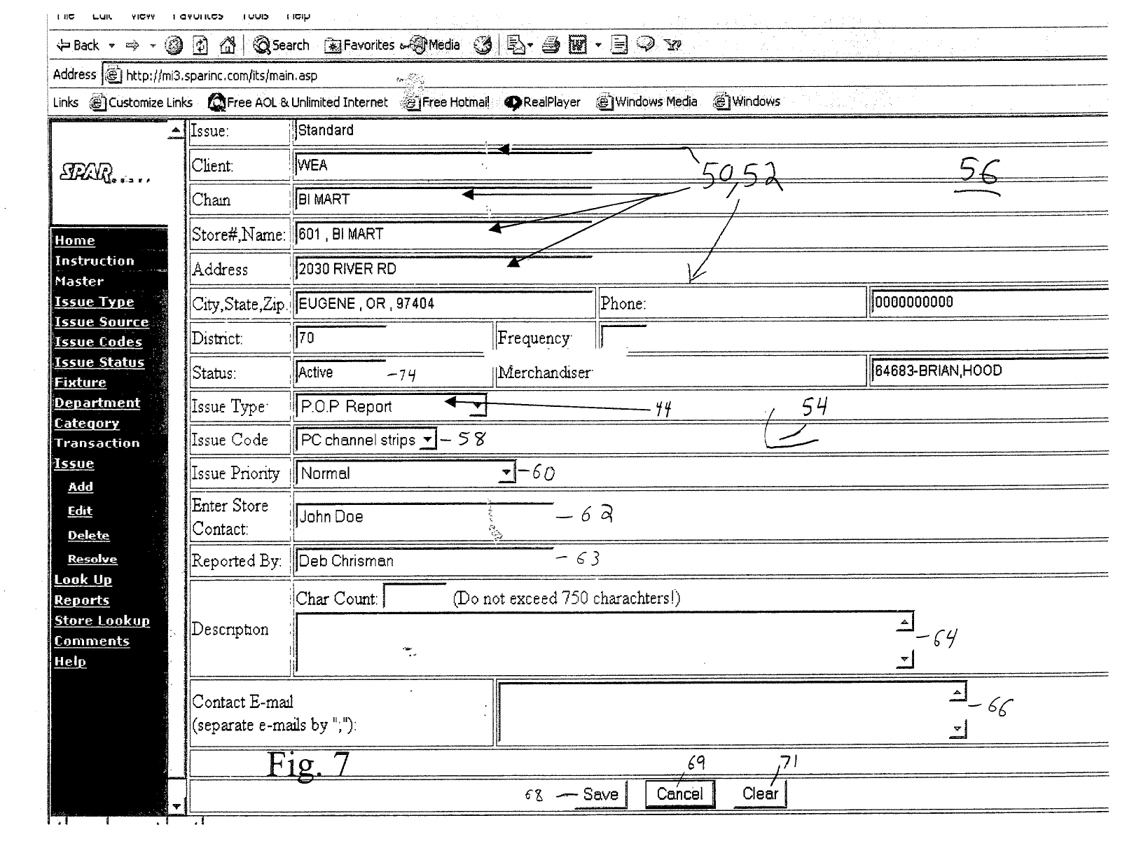

Issue action area 28 preferably contains graphic controls whereby users are able to perform data entry and data editing operations for new issues and existing issues. When a user selects a choice to generate a new issue within issue action area 28, he is preferably prompted to enter new product display issues via two display screens on user terminal 6 as shown in FIG. 6 and FIG. 7.

As shown in FIG. 6, an issue entry screen 32 is presented where the user is prompted to enter new Issue data for a client (e.g. manufacturer) 34, a site (e.g. store chain) 36, a store number 38, and source 40. Although issue entry screen 32 relates to a standard issue, the same fields may also be used for a fixture or retailer issue. Source 40 refers to the person who has contacted system 2 regarding an issue. Examples of source 40 include store manager, client, district manager, merchandiser, claims clerk, department manager, in-store merchandising headquarters, and retail headquarters. Such a list of sources is not exhaustive and system 2 allows for a user to add additional issue titles on-line without the need for a costly programmer.

When the user has completed inputting new issue data in issue entry screen 32, he can click next button 46 to proceed to a second issue data entry screen 56 as shown in FIG. 7. If the user decides not to complete the new issue data entry in issue display screen 32, he can click his mouse or other pointing device on cancel button 48. By clicking cancel button 48 site processor 4 is instructed to cancel the new issue entry operation and the user is preferably presented in-store issue main menu display screen 25. A clear button 47, allows the user to clear data entered into issue entry screen 32.

Should the user click on next button 46 in issue display screen 32 and erroneously omit one or more new issue entry data elements as shown in FIG. 6, he is preferably presented with a message indicating that these omitted data elements must be entered in order to proceed with the operation. Further, the user is preferably prompted to return to complete data entry in issue entry screen 32.

Once the user has successfully completed entering new issue data elements in issue display screen 32 and clicks next button 46, the user is preferably prompted to type additional details as displayed in FIG. 7. Display areas 50 and 52 of second issue data entry screen 56 preferably show data entered during the previous step of data entry in first issue data entry screen 32 shown in FIG. 6. Display areas 50, 52 afford the user the opportunity to review data entry already entered.

For example, display area 50 shows the store chain, client and store number . Display area 52 shows store information including the name, address, district, telephone number and status of the store. Display area 52 is comprised of specific data elements entered during initial entry (not shown) of the store number in database 5 of in-store issue tracking system 2 and is retrieved from database 5 based on the store number entered by the user.

Issue detail action area 54 as shown in FIG. 7 enables the user to enter particular information pertaining to the in-store-related issue. The user is prompted to enter an issue type 44, an issue code 58, a priority weight value 60, a contact person 62, report person 63, and a free-text description of the in-store issue 64. Issue type 44 provides for a categorization of the type of in-store issues being reported. Examples of issue type 44 include fixture, manufacturer, returns, graphic, retailers, space reports, stock reports, and store status. These choices represent the types of in-store issues encountered by manufacturers, in-store merchandising companies, merchandising specialists, store personnel and the like. Issue code 58 preferably depends upon the value entered in issue type 44 on issue display screen 32. Each issue type 44 has a corresponding set of codes 58 stored in database 5. For example, an issue type 44 with a value “fixture” may produce selection examples in a drop-down menu in issue code 58 such as installation, video fixture or other. Alternatively, if the value “merchandiser” was entered in issue type 44, code 58 may include choices for no show, visit or void.

In addition to issue codes, the user is prompted to enter a priority value of normal to high to indicate a relative severity of the issue, thereby defining the speed at which the selected issue requires resolution. Based on this priority, a timer in system 2 assigns a resolution deadline and optionally generates automated reminders (e.g. e-mails) as appropriate. When an issue is first entered, its status 74 is considered ” active”. When the issue is resolved, its status 74 is considered ” resolved ”. If the issue is not resolved, upon expiration of the resolution deadline, the issue status is changed from “active” to “exception”. When the status of an issue changes to “exception”, an e-mail is generated to notify applicable individuals listed in database 5.

The user also enters a summary of the issue in issue description area 64.

As shown in FIG. 7, the user is prompted to enter one or more e-mail addresses of additional recipients 66 (which may be in addition to those included in a system address book) who the user would like to receive e-mail notification of the in-store-related issue. The recipients of the e-mail notice include those entered by the user in e-mail recipients 66, and other recipients who receive automatic e-mail notifications according to default parameters programmed within in-store issue tracking system 2 and stored in database 5. Examples of additional e-mail recipients include supervisors of merchandising specialists and system administrators. The user may optionally also send to a voice mail to a desired individual with details relating to the issue.

Merchandising specialists may have supervisors who oversee and assign activities. When in-store issues are entered into in-store issue tracking system 2, such supervisors are preferably automatically notified of the issue details.

Additionally, personnel responsible for software and hardware maintenance of in-store issue tracking system 2 may receive automatic e-mail notifications for record keeping of the performance of in-store issue tracking system 2.

Although manual e-mail notification is described above for the case where the user enters the e-mail addresses of those who are to receive notification, it is further contemplated that a fully automatic e-mail notification function can be used. Such a fully automatic e-mail function is implemented by linking the e-mail addresses of designated personnel with associated records in database 5, e.g. site (chain), store, client (manufacturer), etc.

As one of skill in the art would understand, each data element in the database is categorized and stored in one of a number of fields. For example, supervisors Zachary Aaron and Joseph Smith are stored in a personnel data element table and are categorized under a Supervisor Name field. Similarly, store numbers 1234 and 5678 are stored in an issue data elements table for individual stores and are categorized under a Store Number field.

Fields which include the same data in different database tables are considered “linked”. For example, the database table storing personnel data might include the supervisor's name, contact information, direct reports, and chain and store numbers for which the supervisor is responsible. An issue data database table might also include fields, which identify the chain and store number corresponding to the issue. The chain and store number fields in the personnel database table and the chain and store numbers in the issue database table include the same data and are therefore linked fields.

For example, a supervisor's e-mail address can be found by searching the personnel data using a data element in a linking field, for example the chain and store number, corresponding to the issue data. In this manner, a supervisor's data record is linked to a set of stores within a region such that the supervisor is alerted any time a new issue is opened, or when an issue is resolved or followed-up for stores in the supervisor's region. As another non-limiting example, database records can be linked such that an executive of the merchandising company (this may include a retailer or manufacturer) receives a notification each time a new issue is opened, or when an issue is resolved or followed-up involving any of the manufacturer's products including systematic status rollover when an automatic e-mail is sent.

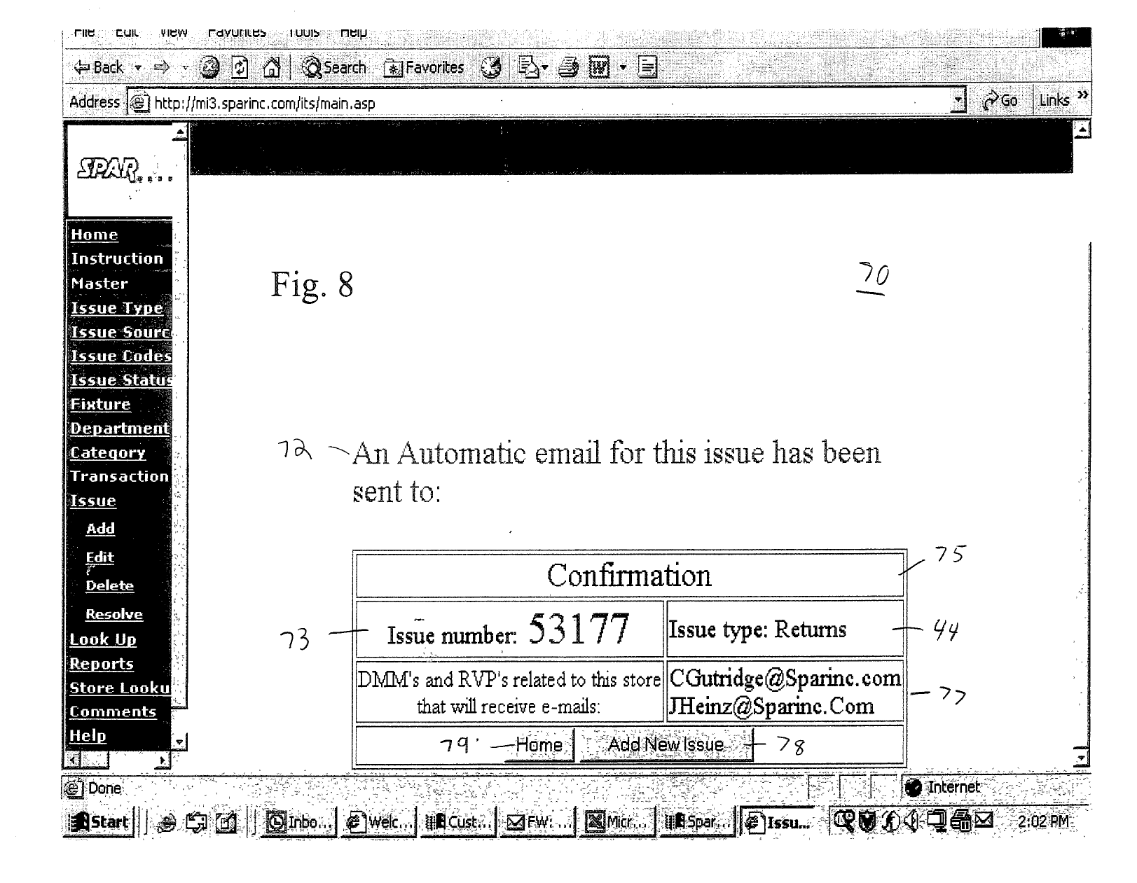

Upon completion of data entry in issue detail action area 54 and e-mail recipients area 66, the user is preferably prompted to click her pointing device on save button 68. Selecting save button 68 enters the issue into the database on site processor 4 and instructs site processor 4 to generate issue entry confirmation display screen 70 as shown in FIG. 8. By clicking save button 68 the in-store issue tracking system additionally instructs site processor 4 to automatically generate certain issue data corresponding to the newly entered issue. Alternatively, the user may click on cancel button 69 to cancel the issue or clear button 71 to clear the data in issue detail area 54. Referring to FIG. 8, examples of automatically generated issue data by site processor 4 include an issue number 73. Issue number 73 is preferably a unique alphanumeric string which identifies the issue and enables users to locate and continue data processing for existing issues.

FIG. 8 shows an example of issue entry confirmation display screen 70. Once a new issue has been submitted, the user is notified via e-mail confirmation area 72 that an automatic e-mail notification has been sent. Clearly the e-mail may first be stored for some period of time before it is sent. Issue entry confirmation display area 75 includes an issue number 73 an issue type 44 and an indication 77 to whom notification e-mails were sent. The information in display area 75 provides the user with reference information for future use. The user is prompted to input additional issues or return to main menu display screen 25 via an Add New Issue button 78 and a Home button 79, respectively.

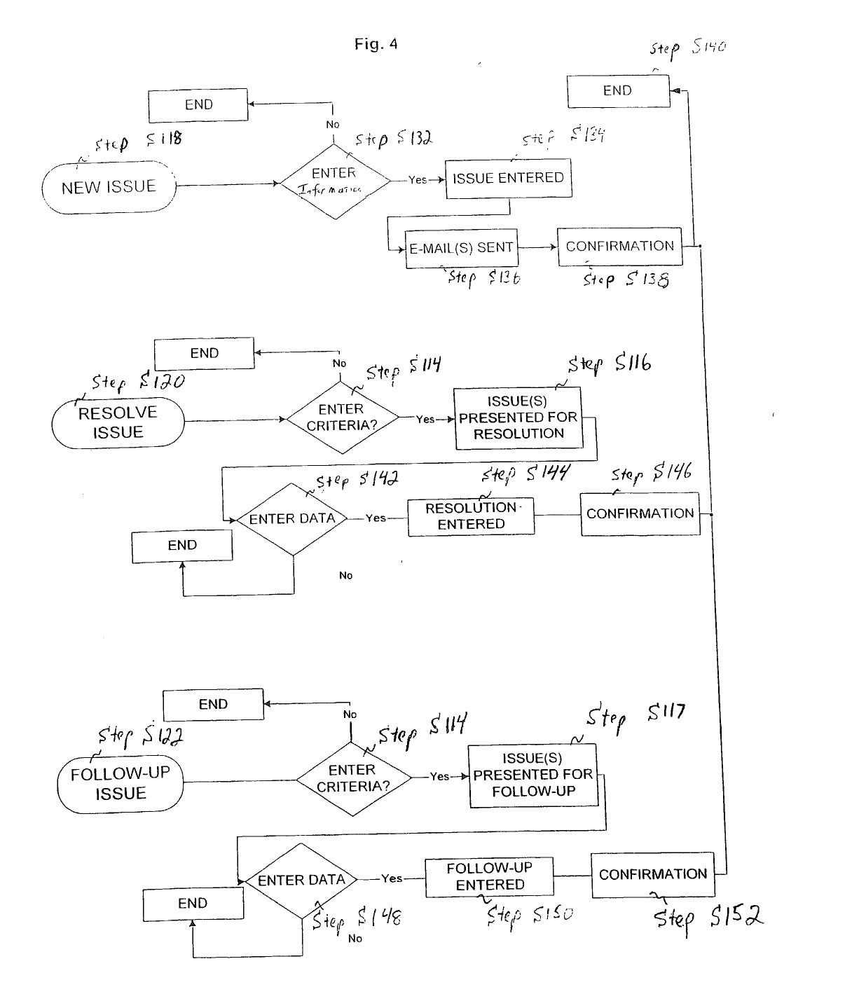

In summary, referring to FIG. 4, when the user selects the option of entering a new issue at step S118, he is instructed to enter the appropriate information at step S132 (FIGS. 6 and 7). Once the information is confirmed, the user clicks on yes button 68 (FIG. 7) and the issue is entered at step S134. Applicable e-mails are sent at step S136 and a confirmation (FIG. 8) is displayed to the user at step S138.

Referring again to FIG. 5, once an issue is entered into system 2, a user may desire to resolve or follow up on that issue. Clicking on either “Resolution to an issue” or “Follow up on an issue” in issue action area 28, produces issue retrieval display screen 80.

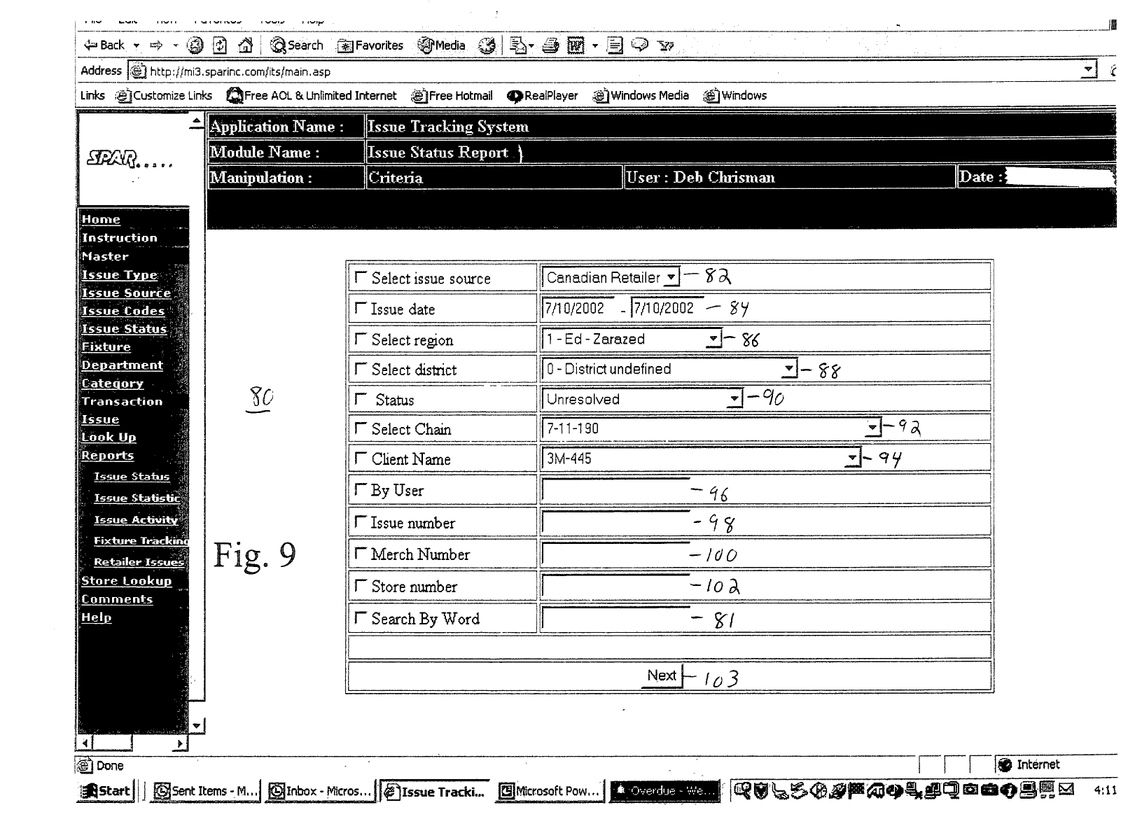

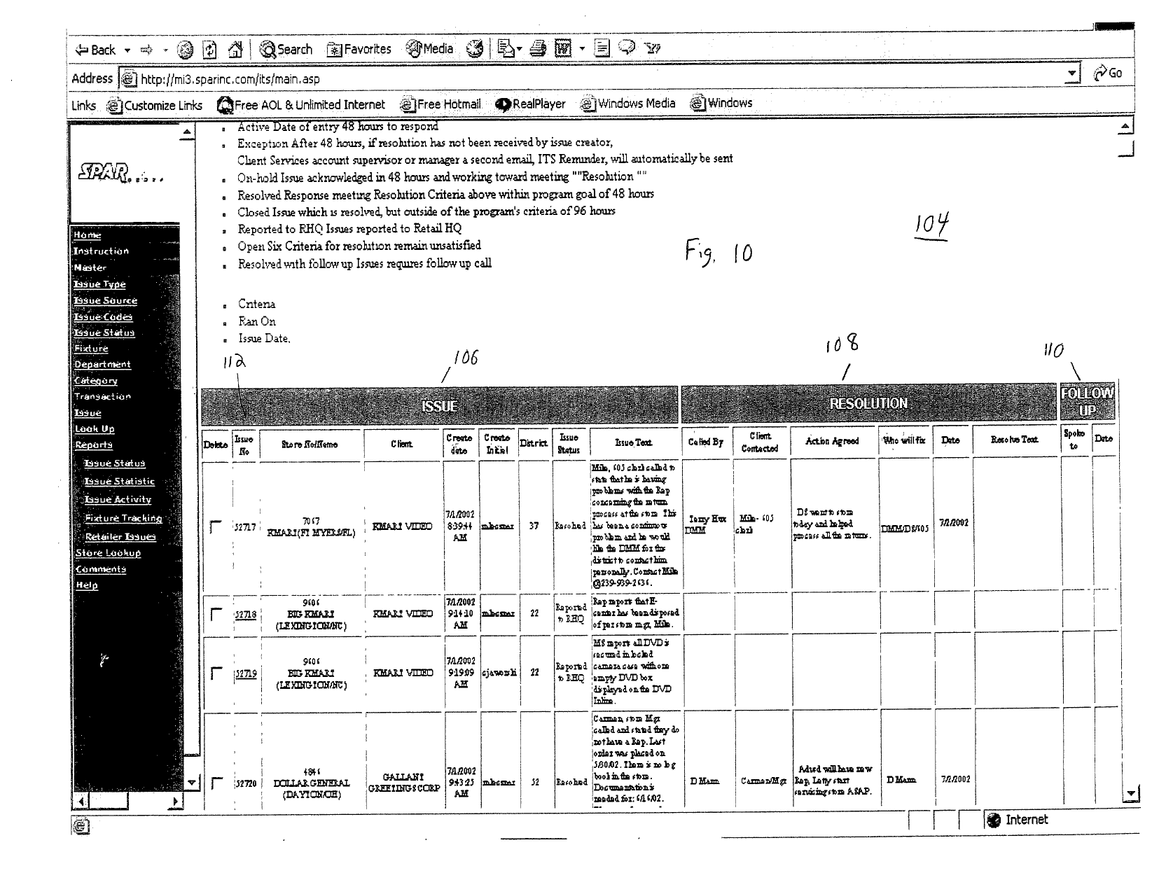

FIG. 9 shows an example of issue retrieval display screen 80. Issue retrieval display screen 80 facilitates a preferred method for retrieving specific issues for review and modification from in-store issue tracking system 2. Issue data which were entered in issue display screen 32 and issue display screen 56 and stored in database 5 are represented in issue retrieval display screen 80 and the same data elements are utilized for retrieving specific issues from in-store issue tracking system 2. The issue retrieval data elements in issue retrieval display screen 80 preferably are criteria for selection processes, and do not modify the database in any way.

Preferably, a user is prompted via issue retrieval display screen 80 to submit selection criteria to invoke a querying process on site processor 4 and retrieve in-store-related issues which meet the entered specification criteria. Examples of selection criteria include text 81, title 82, date range 84, geographic region value 86, district value 88, status of the issue 90, store chain 92, merchandiser name 94, user I.D. 96 of the person using in-store issue tracking system 92, issue number 98, merchandiser number 100 and individual store number 102. User I.D. 96 corresponds to the personal identification code the user entered when logging into in-store issue tracking system 2. Date range 84 refers to a first date and last date to retrieve issues which were entered during the given time period. Geographic region 86 represents regions within the world where stores are located.

Issue retrieval display screen 80 is preferably designed such that the user enters one or a combination of data entry elements as shown in FIG. 9 to provide for as broad or narrow a search for specific in-store issues as desired. The user clicks on corresponding check boxes to indicate to site processor 4 the one or more criterion the user wishes site processor 4 to use for the retrieval query. The user is preferably prompted to click on a next button 103 after boxes corresponding to selection criteria have been selected. By clicking on next button 103, site processor 4 is instructed to invoke the query retrieval process and the user is thereafter able to review the results generated by site processor 4. For example, a user can retrieve issues determined by selecting a specific store during a specific date range with a specific status and entered by a specific user. This produces a small subset of in-store issues.

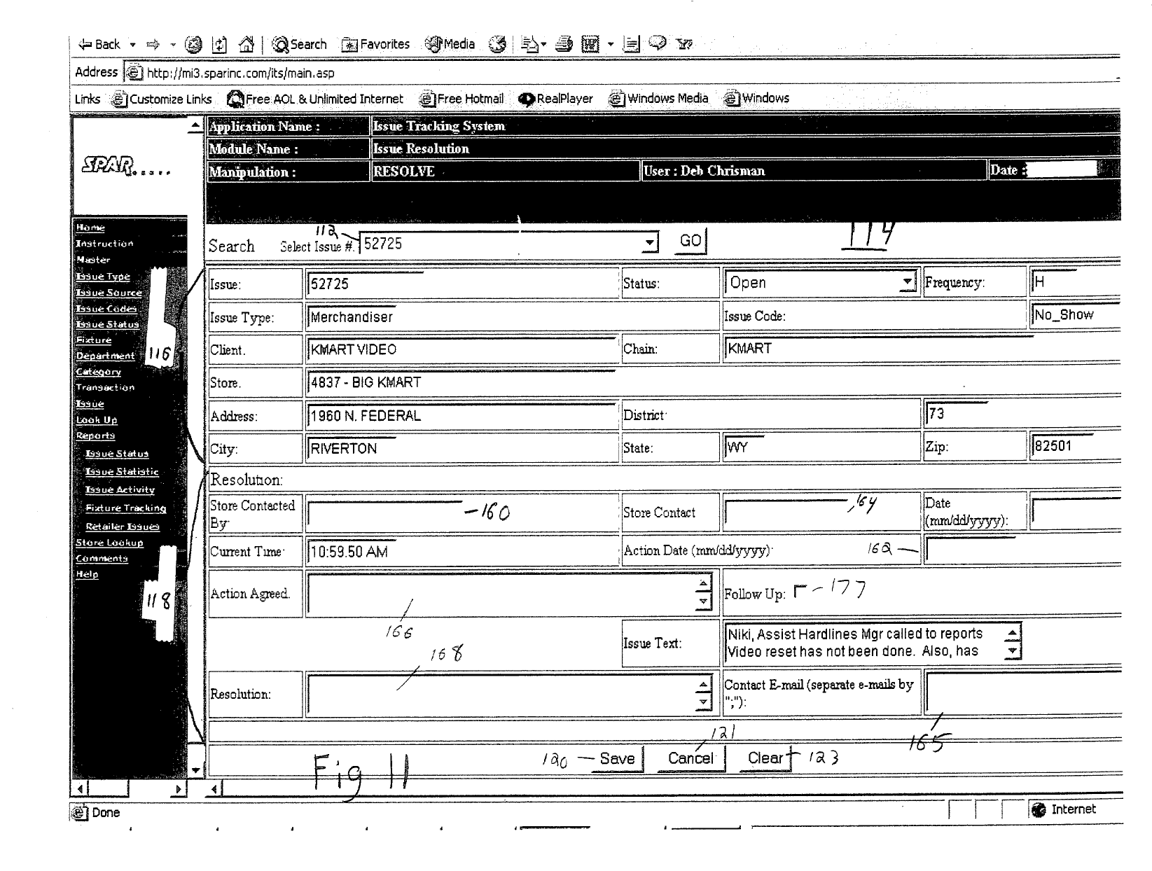

Conversely, a user can retrieve all issues from a wide date range, for example every issue for all stores for all manufacturers for the current year. This produces a large subset of in-store issues. After the user clicks next button 103, he can review the results generated by the issue retrieval query process. An example of a display screen resulting from the issue retrieval query process is shown in FIG. 10.

FIG. 10 shows an example of an issue report display screen 104. The data displayed in issue report display screen 104 is based on the data retrieved in accordance with the search parameters entered in an issue retrieval display screen 80. The user is able to review specific issue description data in issue description area 106, resolutions to specific issues in a resolution display area 108 and the user can review any follow-up communication to issues in follow-up display area 110. The user may also be given the option of deleting displayed issues.

If a user desires to view more detail or make modifications to an issue displayed in in-store issue report screen 104, the user may click on issue number 112. Issue number 112 refers to the issue number 73, automatically generated by site processor 4 upon entering a new issue. Issue number 112 is preferably an active hyperlink which, when selected, instructs site processor 4 to generate display screens corresponding to the specific selected issue.

FIG. 11 represents an example of issue resolution entry screen 114 as preferably displayed on user terminal 6 when the user desires to resolve an issue. Issue resolution entry screen 114 is generated when 1) the user clicks on issue number 112 and 2) the selected issue has not yet been resolved. Issue resolution entry screen 114 affords the user an opportunity to resolve an otherwise unresolved active issue. Issues that are entered into in-store issue tracking system 2 are effectively unresolved until further action is taken upon them. By retrieving the issue substantially as shown in issue retrieval display screen 80 and then clicking on issue number 112 in issue report display screen 104, a user can take further action on issues and provide resolution information. Issue resolution entry screen 114 affords users the opportunity to resolve active in-store-related issues.

Issue resolution entry screen 114 includes issue display area 116 which provides details including issue number, issue type, client, store and address, status, chain and code of the in-store-related issue. Issue resolution entry screen 114 also comprises issue resolution action area 118 from which the user enters issue resolution data for the selected in-store-related issue. Examples of resolution data the user can enter include the person who called the store 160, date 162, store contact 164 , the action agreed to be taken 166, the and the actual resolution 168 . The user may send e-mails regarding the resolution to additional recipients in field 165.

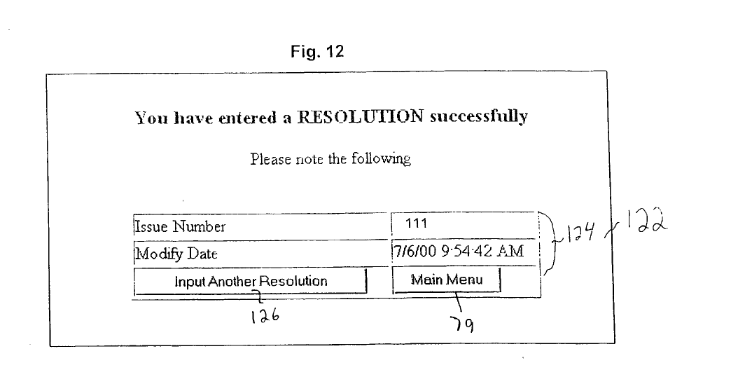

The user may also add a follow up by clicking on button 177 and entering data in follow up screen 128 discussed below. Once the user inputs resolution data elements in the issue resolution screen 114, the user selects save button 120, which enters the in-store issue resolution data in the database of in-store issue tracking system 2. Alternatively, the user may use cancel button 121 or clear button 123. The user will thereafter be presented with a resolution confirmation screen similar to that shown in FIG. 12.

As shown in FIG. 12, in-store issue resolution screen 122 closely resembles issue entry confirmation screen 70 (FIG. 8) in that the user is notified of a successful resolution entry to a specific issue. The user is presented with issue display area 124, which provides an indication that the issue has been resolved. The user is prompted with the option to input another in-store issue resolution via input another resolution button 126, and prompted the option in return to the main menu with button 79.

In summary, referring to FIG. 4, when the user selects the option of resolving an issue at step S120 he is instructed to enter the appropriate criteria at step S114 (FIG. 9). He is then presented with issue report display screen 104 (FIG. 10) at step S116. The user picks one of the displayed issues and enters resolution data (FIG. 11) at step S142. He confirms the resolution data by clicking the yes button 120 at step S144. Thereafter, he receives a confirmation (FIG. 12) at step S146.

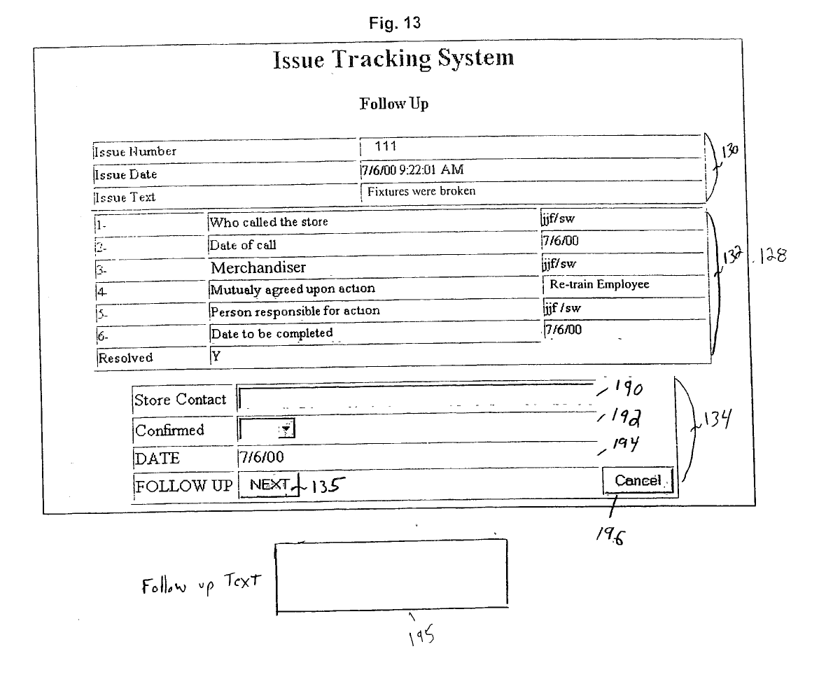

FIG. 13 shows an example of a in-store issue follow-up screen 128 as preferably displayed on user terminal 6. Follow-up screen 128 is generated when 1) the user clicks on issue number 112 (FIG. 10) and 2) the selected issue has been resolved OR when the user clicks on follow-up button 177 in FIG. 11. Follow-up communications can be documented for issues that have been entered and resolved in in-store issue tracking system 2. Users may desire to have continuing communications regarding issues that could potentially return, despite being resolved. Upon following-up specific issues, users document follow-up communications via in-store issue follow-up screen 128.

Issue follow-up screen 128 preferably includes issue display area 130 which provides details including issue number, original entry date of the issue and in-store issue text originally entered in issue description 64 (FIG. 7). A second issue display area 132 is also provided within issue follow-up screen 128 which displays substantially the same data elements previously entered in issue resolution action area 118 (FIG. 11). Included in issue display area 132 is the name of the person who called the store, the date of the call, the merchandiser, the action to be taken, the date the action is to be completed and whether the issue has been resolved. Issue follow-up screen 128 also comprises issue follow-up action area 134 from which the user enters the store contact 190, i.e., the person who was contacted at the store, and a confirmation 192 to confirm that the follow-up took place. The date of the follow-up is displayed at 194. Any follow-up text is entered at 195. The user is also preferably prompted to proceed by clicking next button 135 to enter the issue follow-up into the database of in-store issue tracking system 2 or to cancel by clicking button 196.

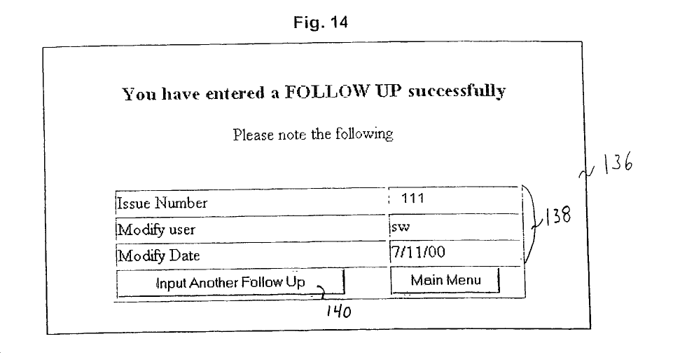

FIG. 14 represents an example of in-store issue follow-up confirmation screen 136. Issue follow-up confirmation screen 136 closely resembles issue resolution confirmation screen 122 (FIG. 12). An issue display area 138 of issue follow-up confirmation screen 136 indicates the issue number, the user who modified the issue and the date of the modification. The user is prompted to input another follow-up to an in-store issue by input another follow-up button 140 or to return to the main menu with button 79. If the user clicks on input another follow-up button 140, he is preferably presented with issue retrieval entry screen 80 again.

In all three cases, whether the user is entering a new issue, resolving an existing issue, or entering a follow-up communication to an existing issue, the user is preferably presented with a confirmation screen, which indicates that he has successfully completed the operation. Additionally, e-mail notifications are preferably transmitted to appropriate parties, for example supervisors, notifying them of a new issue, a resolution to an issue or a follow-up to an existing issue. Thereafter, the user is preferably presented with in-store issue tracking main 25 menu display screen for further in-store issue processing.

Referring again to FIGS. 3 and 5, the present invention includes three exemplary summary reports for in-store issues. Of course, additional reports can be added or reports currently available can be modified or removed as needed.

The report choices include reports which, when selected, provide in-store issue status, issue statistics or issue activity. Selecting issue status report causes site processor 4 to branch to step S108 and produce a detailed report showing details of a particular issue. The details include store name, merchandiser, issue date, and issue description. Additional details in the issue status report include descriptions of resolutions to an issue and follow-up communications regarding an issue, where appropriate.

The issue statistics report step S110 provides statistics relating to various issue types, compared with a larger group of issues. For example, a report may show the percentage of all issues for product returns or problems with fixtures with respect to all issues for a particular manufacturer, store, etc.

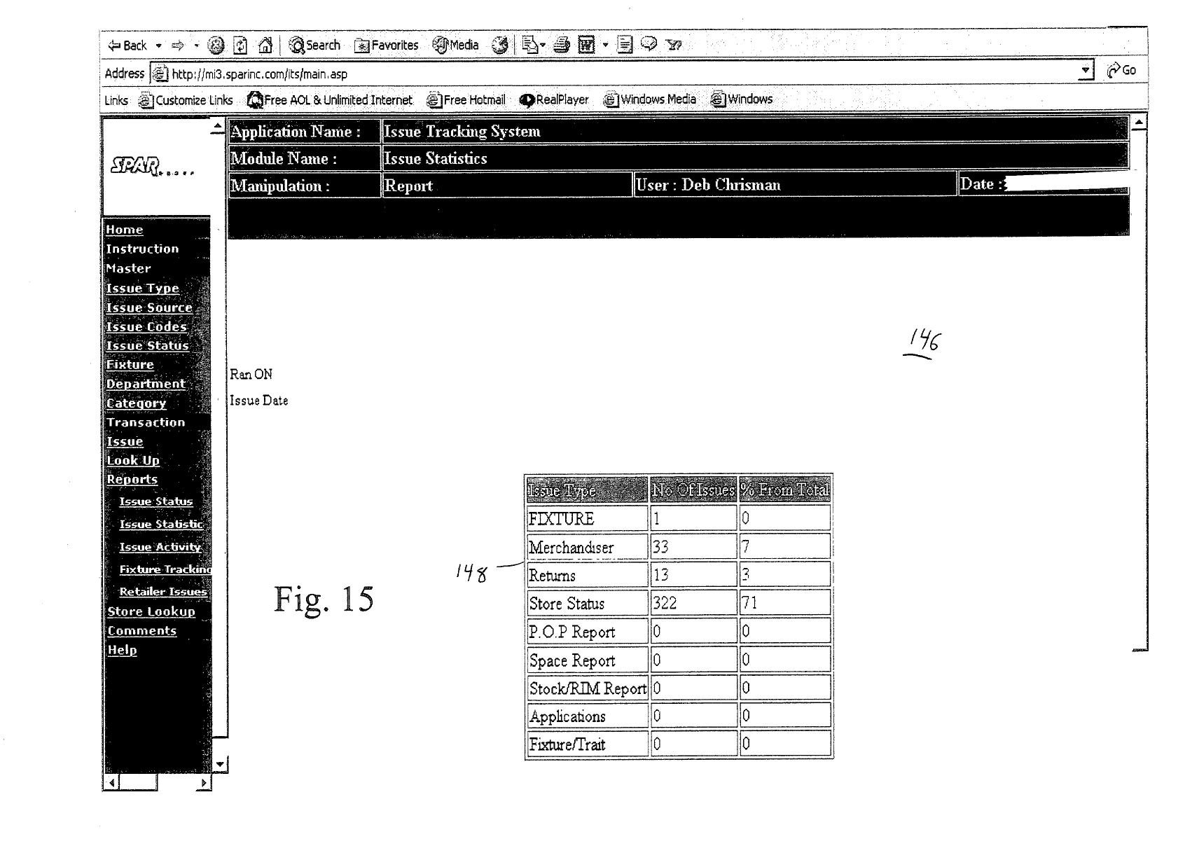

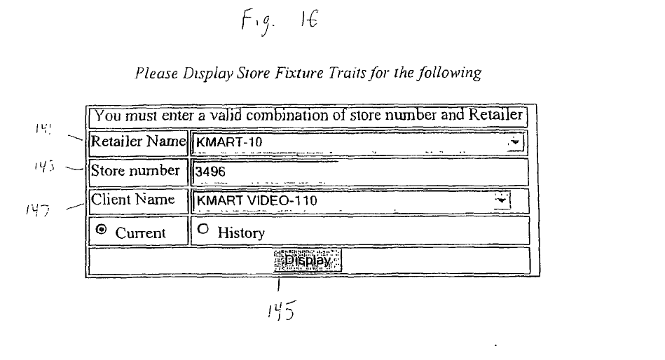

FIG. 15 represents an example of an issue statistics report 146. If a user desires to view statistics of issue types, he preferably selects the statistics report choice from issue report area 26 in in-store issue main menu display screen 25. The user is preferably presented with issue retrieval display screen 80 (FIG. 9) whose search criteria are substantially the same as those described above. The user enters selection criterion and clicks next button 103 to instruct site processor 4 to generate a report of issue percentages.

Statistics report 146 is comprised of report area 148 which includes the number of product display issues and the percentage that each of those product display issues represent of the total number of issues. For example statistics report 146 shows the percentages of fixture, merchandiser, return, store status and programmatic software application issues compared with the total number of a selected subset of issues. This report is helpful to identify percentages of issue-types to total issues for store chains, manufacturers or individual stores. The user is preferably prompted to click on main menu button 150 to be presented with in-store issue main menu 25.

As shown in FIG. 18, issue activity report step S112 provides a summary of issue related data. The summary may be based on a desired date range and may include, for example, the issue source, region, district, status of the issue, chain, client, user, issue number, merchandiser number, or store number. When the user selects issue status report, issue statistics report or issue activity report, he is presented thereafter with an issue retrieval display screen 80 (FIG. 9). The issue retrieval display screen enables the user to enter selection criteria and sends instructions to site processor 4 to query the database residing on site processor 4 to retrieve in-store-related issues based upon the selection criteria. The system offers error protection in that the user is notified if invalid data are entered in the issue retrieval display screen and is preferably prompted to reenter the selection criteria. The user is preferably presented with report output at step S116 in the case where the selection criteria has been properly entered.

As still another alternative to generating reports and entering in-store-related issues, in-store issue tracking system 2 provides a mechanism for tracking at least one category of issue types. Categories include, for example store fixtures and retailer issues.

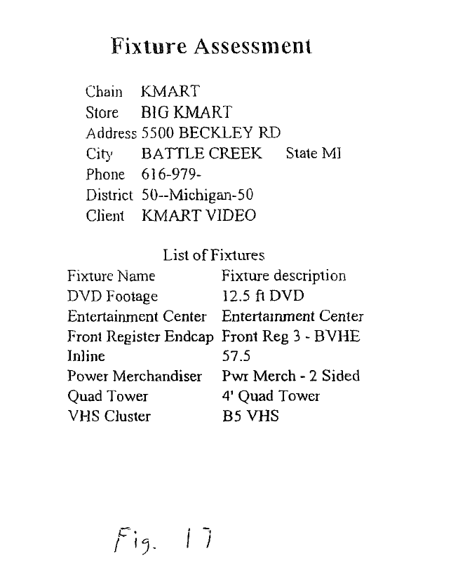

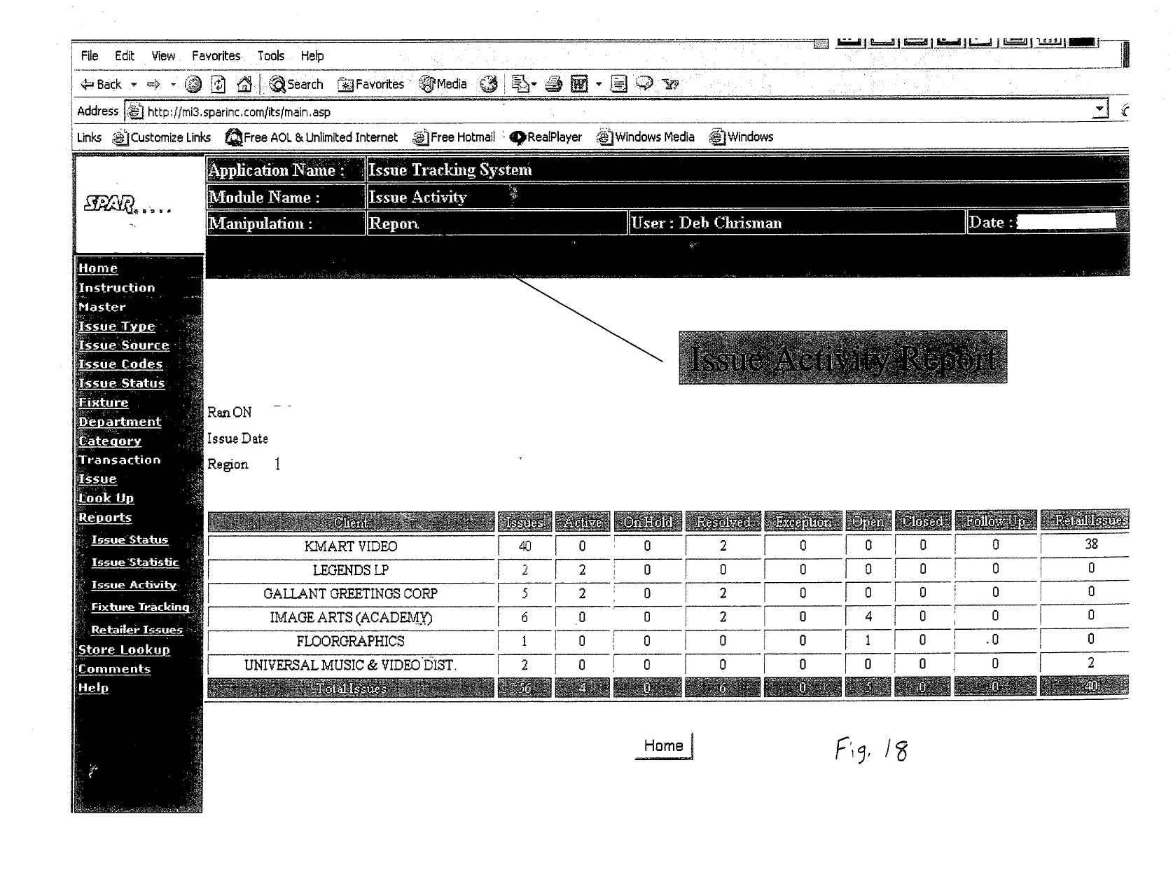

Referring again to FIG. 5, if a user selects the store fixtures report option, control branches to step S124, and the user is presented with a fixture assessment criteria screen 142 shown in FIG. 16. Fixture assessment criteria screen prompts the user to enter one or more criterion including the retailer name 141, store number 143 and the client name 147 pertaining to the product display fixtures that the user wishes to review. Additionally, the user is prompted to make a selection regarding current fixture assessments or a history of fixture assessments for a given store chain, store number and manufacturer. The user is further able to enter reports, which include or exclude a selected fixture type or description. The reports may be sorted by any criteria selected by the user including sorting by fixture type or description. The user is preferably prompted to click on a button 145 to instruct site processor 4 to generate the fixture assessment report output screen (step S130). An example of a fixture assessment display screen is shown in FIG. 17.

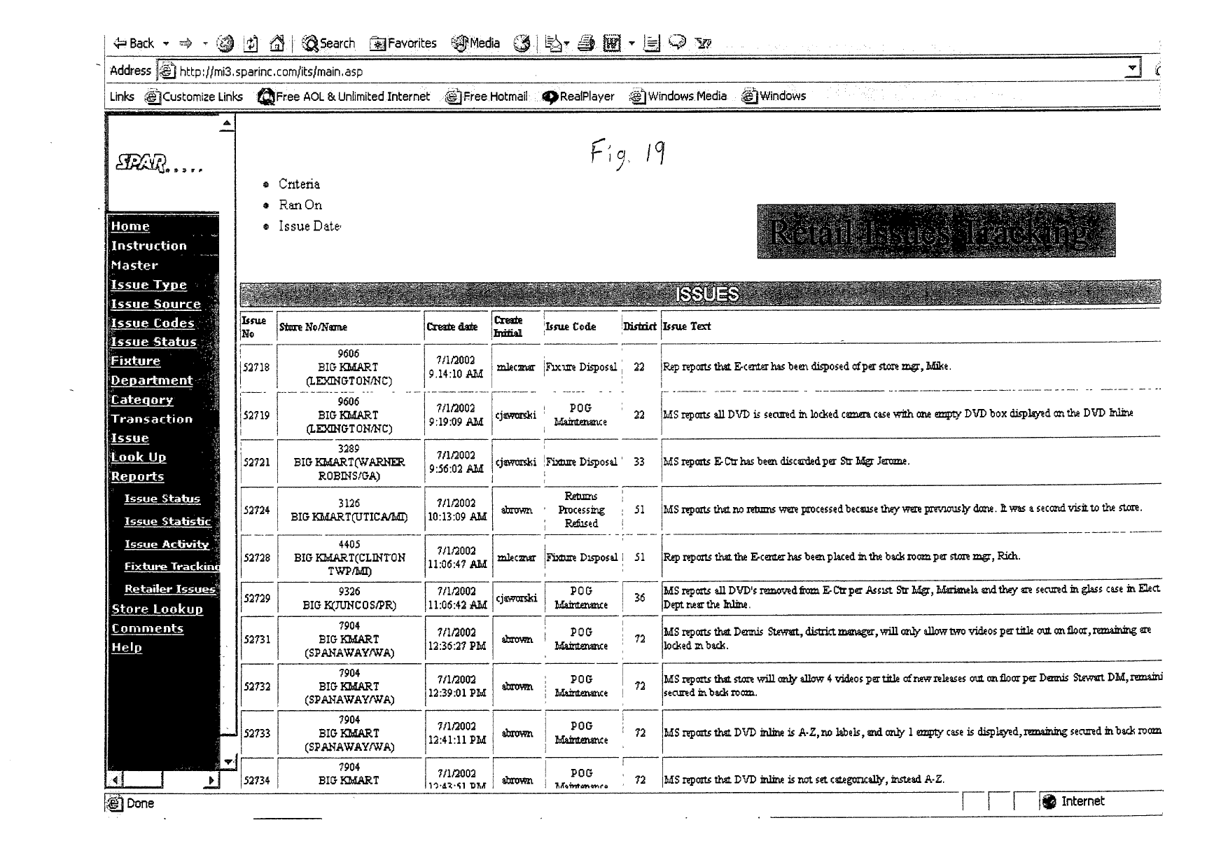

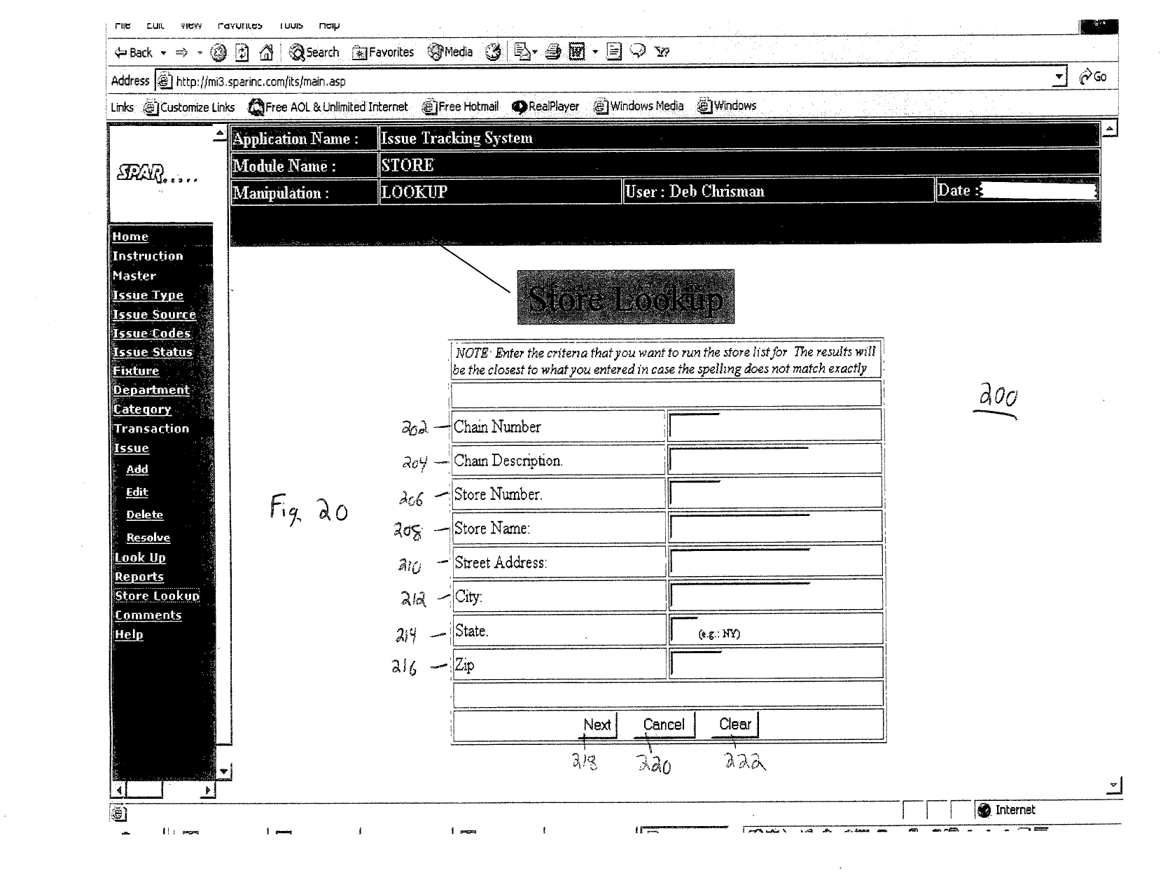

Referring again to FIG. 5, if the user selects tracking retailer issues, control branches to step S126 and site processor 4 is instructed to retrieve in-store issues specifically related to retailers. For example, when selecting retailer issues, the user is preferably presented with an issue retrieval display screen 80 (FIG. 9) substantially similar to that as discussed above. The user is prompted to enter one or more criterion, including a title of the person who entered the in-store issue, an issue type, an issue code, a range of dates for specific retailer issues, a geographic region for stores, the district for the retailer product type and display issues, the store name, the user I.D., or the store number. The user is prompted to click on a button to transmit retailer report selection criterion to site processor 4 to generate the report output which is provided to user terminal 4 at step S130 and is shown in FIG. 19.

FIG. 20 shows an example of a store lookup query screen 200. Query screen 200 allows a user to ascertain the store number of a store using one of many field entries as shown in the figure. For example, the user may enter the chain number 202, chain description 204, store number 206, store name 208, address 210, city 212, state 214, or zip code 216. The user then clicks on next button 218 to confirm his entry, cancel button 220 to cancel the query, or clear button 222 to clear data in query 200. Once equipped with the store number, the user may more easily run reports.

It is noted that while the present invention is described in terms of product-related issues, the invention is not so limited. The invention can be easily modified to provide on-line, real-time issue resolution tracking for a variety of industries and applications in which disparate users are able to enter, resolve and follow-up issues.

The present invention advantageously provides a comprehensive network-based facility which allows a variety of participants in the product chain to communicate in-store and product return issues with each other using a simple web browser interface. A plurality of users receive the same communication firsthand and substantially instantaneously. Additionally, an unlimited number of users can log in and enter, monitor or resolve the types of product-related issues discussed herein limited only by the capacities of communication network 8 and site processor 4.

The present invention advantageously functions to automatically notify via follow-up e-mail, issues which are entered, resolved or followed-up. Users of the system can enter their own requests independently and e-mail communications are triggered automatically without the need for system-provider personnel intervention. The invention therefore allows merchandising programs to operate at peak efficiency, producing a high commercial gain, high customer satisfaction and a successful return on investment.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A method for processing issues in a system including a site processor coupled to at least one terminal through a network, the method comprising:
receiving issue information relating to an issue;
storing the issue information relating to the issue in a database;
receiving resolution information through the network, the resolution information relating to a resolution of the issue; and
storing the resolution information in the database.

2. The method as recited in claim 1, further comprising:
receiving a request by a user through the network to review the issue information; and
providing at least part of the issue information to the user.

3. The method as recited in claim 1, further comprising:
receiving follow-up information relating to a follow-up of the resolution; and
storing the follow-up information in the database.

4. The method as recited in claim 1, wherein upon receiving the issue information, the method further comprises automatically sending at least a portion of the issue information to a predetermined individual.

5. The method as recited in claim 4, wherein the automatically sending is performed by one of sending an electronic mail and a voice mail.

6. The method as recited in claim 1, further comprising automatically sending the resolution information to a predetermined individual.

7. The method as recited in claim 1, further comprising:
receiving a request through the network for the state of the issue from a user; and
providing the user with the state.

8. The method as recited in claim 1, further comprising:
receiving a request through the network for a report from a user; and
providing the report to the user.

9. The method as recited in claim 1, wherein the issue information includes a store name and an issue type.

10. The method as recited in claim 1, wherein the issue information further includes a priority.

11. The method as recited in claim 1, wherein the issue relates to a product display.

12. The method as recited in claim 1, wherein the issue information includes an e-mail address.

13. A system for processing issues, the system comprising:
a system processor;
at least one terminal coupled to the system processor through a network; and
a database coupled to the system processor;
wherein:
the terminal sends issue information through the network to the system processor, the issue information relating to an issue;
the system processor stores the issue information in the database;
the system processor receives resolution information through the network, the resolution information relating to a resolution of the issue; and
the system processor stores the resolution information in the database.

14. The system as recited in claim 13, wherein:
the system processor receives a request through the network from a particular one of the terminals to review the issue information; and
the system processor provides at least part of the issue information to the particular terminal.

15. The system as recited in claim 13, wherein:
the system processor receives follow-up information relating to a follow-up of the resolution; and
the system processor stores the follow-up information in the database.

16. The system as recited in claim 13, wherein upon receiving the issue information, the system processor automatically sends at least a portion of the issue information to a predetermined individual.

17. The system as recited in claim 16, wherein the system processor automatically sends the portion of the issue information by one of electronic mail and voice mail.

18. The system as recited in claim 13, wherein upon receiving the resolution information, the system processor automatically sends the resolution information to a predetermined individual.

19. The system as recited in claim 13, wherein:
the system processor receives a request through the network from a particular one of the terminals for the state of an issue; and
the system processor sends the state to the particular terminal.

20. The system as recited in claim 13, wherein:
the system processor receives a request through the network from a particular one of the terminals for a report; and
the system processor sends the report to the particular terminal.

21. The system as recited in claim 13, wherein the issue information includes a store name and an issue type.

22. The system as recited in claim 13, wherein the issue information further includes a priority.

23. The system as recited in claim 13, wherein the issue relates to a product display.

24. The system as recited in claim 13, wherein the issue information includes an e-mail address.

25. The method as recited in claim 10, further comprising the steps of:
setting a resolution time for a timer based on the priority; and
generating a notification regarding resolution of the issue based on the resolution time.

26. The system as recited in claim 13, wherein:
the system processor further sets a resolution time of a timer based on the priority; and
the system processor generates a notification regarding resolution of the issue based on the resolution time.

27. The method as recited in claim 8, wherein:
the report includes a table including a plurality of fields related to the issue information; and the method further comprises
enabling the user to search for a particular issue by entering data in at least one of the fields.

28. The method as recited in claim 8, wherein:
the report includes at least one issue and a corresponding hyperlink; and
when the user accesses the hyperlink, the user is displayed with the issue information and the resolution information for the at least one issue.

29. The system as recited in claim 20, wherein:
the report includes a table including a plurality of fields related to the issue information; and
the system processor enables the user to search for a particular issue by entering data in at least one of the fields.

30. The system as recited in claim 20, wherein:
the report includes at least one issue and a corresponding hyperlink; and
when the user accesses the hyperlink, the user is displayed with the issue information and the resolution information for the at least one issue.
